(19) United States
(12) Patent Application Publication
(10) Pub. No.: US 2014/0141366 A1
(43) Pub. Date: May 22, 2014

(54) TONER AND METHOD FOR MANUFACTURING THE SAME

(71) Applicants: Yasushi Katsuta, Susono-shi (JP); Shinya Yachi, Hadano-shi (JP); Takeshi Shimura, Abiko-shi (JP); Nobuhisa Abe, Susono-shi (JP); Kenta Kamikura, Mishima-shi (JP)

(72) Inventors: Yasushi Katsuta, Susono-shi (JP); Shinya Yachi, Hadano-shi (JP); Takeshi Shimura, Abiko-shi (JP); Nobuhisa Abe, Susono-shi (JP); Kenta Kamikura, Mishima-shi (JP)

(73) Assignee: CANON KABUSHIKI KAISHA, Tokyo (JP)

(21) Appl. No.: 14/232,134

(22) PCT Filed: Jul. 10, 2012
(86) PCT No.: PCT/JP2012/068048

§ 371 Date: Jan. 10, 2014

(30) Foreign Application Priority Data
Jul. 12, 2011 (JP) 2011-153629

(51) Int. Cl. G03G 9/08

(52) U.S. Cl. CPC G03G 9/0821
USPC 430/108.4; 430/137.15

(57) ABSTRACT

In a toner including toner particles obtained by performing suspension polymerization using a monomer composition containing a polymerizable monomer and a polar resin and in a method for manufacturing the above toner, the polar resin satisfies the following conditions (1) to (4). (1) The polar resin is a styrene-based resin. (2) A main peak molecular weight Mp is 5,000 to 100,000. (3) When the acid value of a low molecular weight component is represented by A and the acid value of a high molecular weight component is represented by B, 0.80≦A/B≦1.20 is satisfied. (4) The acid value is 5.0 to 40.0 mgKOH/g.

### TECHNICAL FIELD

The present invention relates to a toner used for recording methods, such as an electrophotographic method, an electrostatic recording method, a magnetic recording method, and a toner jet method, and to a method for manufacturing the toner.

### BACKGROUND ART

An electrophotographic method is a method to obtain a print or a copy in such a way that an electric latent image is formed on a photo conductor by various ways and is then developed by a toner to form a toner image, and after the toner image is transferred on a recording material (transfer material) such as paper, the toner image is fixed thereon by applying heat and/or a pressure.

In recent years, concomitant with development of computers and multimedia, measures to output a further improved high-definition full color image have been desired in a wide range of fields from offices to homes. Heavy users require high durability that prevents degradation of image quality even after many sheets are copied or printed, and in contrast, in small offices and homes, to obtain high quality images is required. Furthermore, in view of space saving and energy saving, there have been requested reduction in size of apparatuses, reuse of waste toner or use of a waste-tonerless (cleanerless) system, a decrease in fixing temperature, and image gloss corresponding to photographic image quality.

In order to satisfy the durability and the fixability at the same time, the viscoelasticity and the melt viscosity of the toner have been discussed. In general, since the toner is degraded when a mechanical friction force is applied thereto in a developing device, it is advantageous to increase the viscoelasticity and the melt viscosity of the toner. On the other hand, in order to realize image gloss and low temperature fixability by reduction of consumption energy in a fixing step, the viscoelasticity and the melt viscosity of the toner must be decreased. However, when the viscoelasticity and the melt viscosity of the toner are decreased, the development performance and the transfer performance are not only disadvantageously influenced, but the storage stability of the toner at a temperature of approximately 50° C. is also degraded. In contrast, when a wax component in a toner particle is likely to instantly bleed out (bleeding property) in a fixing step, it is preferable since the releasing property from a fixing roller is improved. However, if a wax component bleeds out in a developing step, the development property may be degraded by a charging defect of the toner due to the wax component. Although it has been difficult to simultaneously obtain the durability and the fixability as described above, a method which can satisfy the above two performances at the same time has been investigated.

As a method which can solve the above problems, there has been proposed a technique which pays attention to a differential scanning calorimetric (DSC) curve of a toner measured by a DSC apparatus. A toner at least containing a binder resin and a colorant has been proposed in which in a second temperature rise step of the DSC curve of the toner measured by a differential scanning calorimeter, at least one exothermic peak is present in the vicinity of the glass transition point of the binder resin (see PTL 1). Fixability can be improved by this method. However, when the durability on the development performance is taken into consideration, a further improvement is desired.

In addition, there has also been an attempt to improve the low temperature fixability and durability/storage stability by specifying the molecular weight and the acid value of a binder resin of a toner. For example, a method has been disclosed in which a styrene-based resin is used as a binder resin of a toner, and the acid value of the whole binder resin and the acid value of a low molecular weight component thereof are specified (see PTL 2). It is true that by this method, the storage stability can be improved. However, sufficient low temperature fixability is difficult to obtain when print-out is performed at a high speed, and a further improvement is desired.

In addition, a method has been disclosed in which the low temperature fixability and high-temperature offset resistance are improved in such a way that the acid value of a low molecular weight component of a binder resin of a toner is set higher than the acid value of a high molecular weight component thereof (see PTL 3). The low temperature fixability described above can be improved by the method for specifying the acid value of a low molecular weight component of a binder resin and that of a high molecular weight component thereof. However, since the toner is manufactured by a grinding technique in this case, the low molecular weight component and the high molecular weight component are equally present on the surface and inside of each toner particle. Hence, it is difficult to simultaneously obtain high-level durability and fixability of the toner.

In addition, an association method toner excellent in durable stability has been disclosed in which a binder resin of the toner containing a high-molecular weight component and a low-molecular weight component enables each toner particle to have a predetermined hardness (see PTL 4). This association method toner is a toner obtained through the steps of salting-out/welding of resin particles and colorant particles, and the molecular weights of resins forming individual layers of the structure of the resin particle are controlled to be decreased from the central portion to the surface layer of the structure. Hence, the storage stability and the high-temperature offset resistance may be degraded in some cases.

As described above, in order to simultaneously satisfy the durability and the fixability, many investigations on the toner particle in consideration of the internal structure thereof and on the binder resin of the toner have been carried out. However, in consideration of current requirements, such as a higher speed operation and a further improved high-definition full color image, there has been desired a toner which can sufficiently satisfy high durability, high transfer property, and storage stability while maintaining excellent fixability and high image gloss.

### CITATION LIST

### Patent Literature

PTL 1 Japanese Patent Laid-Open No. 2004-184561
PTL 2 Japanese Patent Laid-Open No. 5-53373
PTL 3 Japanese Patent Laid-Open No. 10-090939
PTL 4 Japanese Patent Laid-Open No. 2004-109601

### SUMMARY OF INVENTION

The present invention provides a toner which is excellent in low temperature fixability and image gloss; even if print-out is performed on many sheets, which shows excellent development property and transfer property to obtain a stable image; and which is also excellent in storage stability, and also provides a method for manufacturing the toner.

The present invention relates to a toner comprising toner particles wherein: the toner particles produced by a process including the steps of adding a polymerizable monomer composition containing a polymerizable monomer, a polar resin, and a colorant to an aqueous medium; granulating the polymerizable monomer composition in the aqueous medium; and polymerizing the polymerizable monomer contained in the polymerizable monomer composition, wherein: i) the polar resin is a styrene-based polymer, ii) a main peak molecular weight Mp in a GPC chromatogram of the polar resin is 5,000 to 100,000, iii) the acid value of the polar resin is 5.0 to 40.0 mgKOH/g, and iv) the polar resin satisfies the following relationship:

0.80≦A(mgKOH/g)/B(mgKOH/g)≦1.20

where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.

In addition, the present invention relates to a method for manufacturing a toner comprising the steps of (I) adding a polymerizable monomer composition containing a polymerizable monomer, a polar resin, and a colorant to an aqueous medium; (II) granulating the polymerizable monomer composition in the aqueous medium; and (III) polymerizing the polymerizable monomer contained in the polymerizable monomer composition to form toner particles, wherein: i) the polar resin is a styrene-based polymer, ii) a main peak molecular weight Mp in a GPC chromatogram of the polar resin is 5,000 to 100,000, iii) the acid value of the polar resin is 5.0 to 40.0 mgKOH/g, and iv) the polar resin satisfies the following relationship:

0.80≦A(mgKOH/g)/B(mgKOH/g)≦1.20

where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.

According to the present invention, there can be provided a toner which is excellent in low temperature fixability and image gloss; even if print-out is performed on many sheets, which shows excellent development property and transfer property to obtain a stable image; and which is also excellent in storage stability, and a method for manufacturing the toner.

### BRIEF DESCRIPTION OF DRAWINGS

FIG. 1 is an enlarged view of a developing section of an electrophotographic apparatus.

FIG. 2 is a cross-sectional view of the electrophotographic apparatus.

### DESCRIPTION OF EMBODIMENTS

A toner of the present invention is a toner comprising toner particles wherein: the toner particles produced by a process including the steps of adding a polymerizable monomer composition containing a polymerizable monomer, a polar resin, and a colorant to an aqueous medium, granulating the polymerizable monomer composition in the aqueous medium, and polymerizing the polymerizable monomer contained in the polymerizable monomer composition. In this toner, i) the polar resin is a styrene-based polymer, ii) a main peak molecular weight Mp in a GPC chromatogram of the polar resin is 5,000 to 100,000, iii) the acid value of the polar resin is 5.0 to 40.0 mgKOH/g, and iv) said polar resin satisfies the following relationship:

0.80≦A(mgKOH/g)/B(mgKOH/g)≦1.20

where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.

In addition, a method for manufacturing a toner of the present invention comprises the steps of (I) adding a polymerizable monomer composition containing a polymerizable monomer, a polar resin, and a colorant to an aqueous medium; (II) granulating the polymerizable monomer composition in the aqueous medium; and (III) polymerizing the polymerizable monomer contained in the polymerizable monomer composition to form toner particles. In this manufacturing method, i) the polar resin is a styrene-based polymer, ii) a main peak molecular weight Mp in a GPC chromatogram of the polar resin is 5,000 to 100,000, iii) the acid value of the polar resin is 5.0 to 40.0 mgKOH/g, and iv) said polar resin satisfies the following relationship:

0.80≦A(mgKOH/g)/B(mgKOH/g)≦1.20

where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.

Hereinafter, the present invention will be described in detail.

The toner of the present invention uses as a polar resin, a styrene-based resin having an acid value of 5.0 to 40.0 mgKOH/g, and since the toner is manufactured in an aqueous medium, the polar resin is used to function as an outer layer of the toner.

Capsule-type toners are each formed from an inner layer and an outer layer. In this capsule-type toner, the inner layer is protected by the outer layer. However, when the adhesion between the inner layer and the outer layer is weak, if a stress is continuously applied to the toner, peeling and/or scraping of the outer layer may occur, and the surface condition of a toner particle may be rapidly changed at a certain point in some cases.

In order to overcome this problem, when a styrene-based resin is used as the polar resin, the adhesion between the inner layer and the outer layer is improved, and for example, the peeling of the outer layer can be suppressed. In a suspension polymerization method, since a binder resin which is a primary component of the inner layer is a vinyl polymer, when a styrene-based resin compatible with the binder resin is used as the polar resin in manufacturing of toner particles in an aqueous medium, the adhesion between the inner layer and the outer layer can be improved. In addition, the present inventors believed that since the above polar resin has compatibility with the binder resin while having the polarity, the concentration gradient of the resin having a polar group is generated in the toner particle.

When a suspension polymerization method is used as in the case of the toner of the present invention, after an added polar resin is dissolved in a polymerizable monomer, as a polymerization reaction proceeds, the solubility of the polar resin to the polymerizable monomer is decreased, and as a result, the polar resin is partially phase-separated. Hence, it is considered that since the partially phase-separated polar resin component is localized on the surface of the toner particle and the vicinity thereof, the resin component having a polar group has a concentration gradient in the vicinity of the surface of the toner particle.

Accordingly, the adhesion and the toughness are enhanced, and the development property and the transfer property of the toner are further improved. In addition, in a fixing step, according to the specific internal structure of the toner particle, when dissolved by heating of the toner, the wax is likely to rapidly move on the surface of the toner particle, so that the fixability is also effectively enhanced.

That is, the present inventors believed that in the present invention, since the adhesion between the inner layer and the outer layer of the toner particle is high, the toughness of the toner is high against an external factor generated when the pressure is applied to the toner, and the inner layer component has a bleeding property in heating of the toner, the development performance/transfer performance/fixability are improved.

In the present invention, it is important that the main peak molecular weight Mp in the GPC chromatogram of the polar resin be 5,000 to 100,000. The peak molecular weight Mp is more preferably 5,000 to 50,000.

The durability (and the storage stability) and the low temperature fixability of the toner can be simultaneously obtained when the peak molecular weight Mp of the polar resin is set to 5,000 to 100,000.

When the peak molecular weight Mp of the polar resin is less than 5,000, since the strength of the outer layer of the toner is decreased, the durability and the storage stability are degraded. In addition, when the peak molecular weight Mp is more than 100,000, since the outer layer of the toner is hardened, the low temperature fixability is degraded, and furthermore, the image gloss is also decreased.

In the polar resin used in the present invention, the acid value of a low molecular weight component (component of the polar resin having a molecular weight less than the peak molecular weight Mp thereof) L is necessary to be close to the acid value of a high molecular weight component (component of the polar resin having a molecular weight not less than the peak molecular weight Mp thereof) H. In addition, when the acid value of the low molecular weight component L is represented by A (mgKOH/g), and the acid value of the high molecular weight component H is represented by B (mgKOH/g), 0.80≦A(mgKOH/g)/B(mgKOH/g)≦1.20 must be satisfied, and 0.85≦A(mgKOH/g)/B(mgKOH/g)≦1.15 is more preferable.

When a toner is manufactured in an aqueous medium as in the case of the present invention, and A/B is set in the above range, the durability and the low temperature fixability can be further improved as compared to those of a related toner. When a toner is manufactured in an aqueous medium, since having high compatibility with water, a component having a high acid value tends to be localized on the surface of the toner. Accordingly, among polymer chains of the polar resin, a polymer chain having a higher acid value is more localized on the surface of the toner. That is, when the value A/B is less than 0.80, since being rich in the high molecular weight component, the outer layer of the toner is hardened, and the low temperature fixability tends to be degraded. On the other hand, when the value A/B is more than 1.20, since being rich in the low molecular weight component, the outer layer of the toner is softened, and the durability tends to be degraded.

In addition, the values A and B are each preferably 3.0 to 30.0 mgKOH/g and more preferably 5.0 to 25.0 mgKOH/g. When the values A and B are each set to 3.0 to 30.0 mgKOH/g, the adhesion between the inner layer and the outer layer of the toner particle is particularly enhanced.

In general, in a styrene-based polar resin manufactured by a known related solution polymerization, the acid value of a low molecular weight component is lower than the acid value of a high molecular weight component, and A/B is less than 0.80. The reason for this is considered as described below. When copolymerization is performed, for example, using a methacrylic acid or acrylic acid as a polymerizable monomer component in order to impart the acid value to a styrene-based polar resin, methacrylic acid or acrylic acid, which has higher polymerizability than that of styrene, tends to be polymerized at an early polymerization stage. Accordingly, a molecule which is formed from an early stage of polymerization and which tends to have a relatively high molecular weight has a high ratio of methacrylic acid or acrylic acid and forms a component having a high acid value. On the other hand, a molecule which is formed by polymerization after methacrylic acid or acrylic acid is consumed to a certain extent tends to form a component having a high ratio of styrene and a low acid value, and in addition, since such a molecule is formed by polymerization started at a delayed timing, the molecular weight thereof tends to be low.

In order to set the value A/B in the styrene-based polar resin to 0.80 to 1.20, for example, a method for manufacturing a styrene-based polar resin at an appropriate pressure and a relatively high polymerization temperature may be mentioned. The present inventors believed that when manufacturing is performed at a relatively high polymerization temperature, depolymerization occurs even if a high molecular weight component having a high ratio of methacrylic acid or acrylic acid is produced at an early polymerization stage, and finally, methacrylic acid or acrylic acid is also contained in a low molecular weight component.

In order to set the value A/B in the above range, besides the method described above, for example, there may also be mentioned a method (1) in which a relatively larger amount of styrene is dripped at an early polymerization stage, and a relatively larger amount of methacrylic acid or acrylic acid is dripped at a latter half of the polymerization, and a method (2) in which two types of polar resins having acid values approximately equivalent to each other and different peak molecular weights are mixed together.

In addition, in the polar resin used for the present invention, the acid value must be 5.0 to 40.0 mgKOH/g, is more preferably 5.0 to 30.0 mgKOH/g, and still more preferably 7.0 to 30.0 mgKOH/g. The acid value of the polar resin indicates the acid value of the whole resin including both a high molecular weight component and a low molecular weight component. In the present invention, when the acid value of the polar resin is less than 5 mgKOH/g, the polar resin is not likely to be localized in a surface direction of the toner, and the durability is degraded. In addition, when the acid value of the polar resin is more than 40.0 mgKOH/g, since the polar resin is excessively localized in the surface direction of the toner, the toner surface is excessively hardened, so that the low temperature fixability is degraded, and since the adhesion between the inner layer and the outer layer is also degraded, the durability is degraded.

As a method for adjusting the acid value of the polar resin, as described above, for example, there may be mentioned a method (1) in which copolymerization is performed appropriately using a polymerizable monomer having a carboxyl group or a sulfonic group and a method (2) in which a carboxyl group and/or a sulfonic group is chemically introduced in a styrene-based resin.

The content of the polar resin to 100.0 parts by mass of the polymerizable monomer is preferably 8.0 to 30.0 parts by mass and more preferably 8.0 to 20.0 parts by mass. When the content of the polar resin is set in the above range, since the outer layer of the toner has an appropriate hardness, the durability and the low temperature fixability of the toner are further improved.

In addition, the polar resin preferably satisfies the following relationship:

1.0≦S1/S2≦1.8

S1 represents a area rate of a lower-molecular weight component in a chart obtained by the GPC chromatogram and S2 represents a area rate of a higher-molecular weight component in a chart obtained by the GPC chromatogram when the chart is divided into two areas at the peak molecular weight Mp of the polar resin.

When the value S1/S2 is in the above range, the low molecular weight component and the high molecular weight component are allowed to be present in the outer layer of the toner at an optimal ratio. Hence, the outer layer of the toner has an appropriate hardness, and the durability and the low temperature fixability of the toner can be further improved. The content ratios S1 and S2 are area rates of the respective components in a chart obtained by the GPC chromatogram.

As a method for setting the value S1/S2 in the above range, for example, there may be mentioned a method (1) in which the control is performed by the type of initiator and/or the amount thereof in manufacturing of the polar resin, a method (2) in which the control is performed by addition of a cross-linking agent to increase the high molecular weight component, a method (3) in which the control is performed by addition of a chain transfer agent to increase the low molecular weight component, and a method (4) in which the adjustment is performed by addition of a high molecular weight component and/or a low molecular weight component.

In the present invention, the glass transition temperature Tg of the polar resin is preferably 70.0° C. to 110.0° C. and more preferably 80.0° C. to 100.0° C. When Tg of the polar resin is set in the above range, the durability and the low temperature fixability of the toner can be further improved.

As a method for controlling Tg of the polar resin, for example, there may be mentioned a method (1) in which the type of polymerizable monomer used for the polar resin is selected to satisfy the range of Tg of the present invention, and a method (2) in which the control is performed by changing the molecular weight using the type of initiator and/or the amount thereof.

The polar resin used for the present invention is preferably a vinyl resin containing at least 50.00 percent by mass of a unit derived from styrene and is more preferably at least 70.00 percent by mass thereof. As particular examples of a monomer used for copolymerization with styrene, for example, styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; unsaturated carboxylates, such as n-butyl acrylate and methyl methacrylate; polymerizable monomers, such as vinylbenzoic acid and its derivative; nitrogen-containing monomers, such as dimethylaminoethyl methacrylate and diethylaminoethyl methacrylate; nitrile monomers such as acrylonitrile; halogenated monomers such as vinyl chloride; unsaturated carboxylic acids, such as acrylic acid and methacrylic acid; unsaturated dibasic acids; unsaturated dibasic acid anhydrides; and nitro monomers may be mentioned. After being formed into a macromonomer by polymerization to a certain extent, these monomers each may also be polymerized with styrene.

The ratio of the unit derived from styrene is determined by ¹H-NMR (nuclear magnetic resonance) measurement. In particular, the ratio is calculated from a peak area of ¹H of a benzene ring derived from styrene.

In the present invention, in order to enable the styrene-based polar resin to have an excellent charging property, a copolymer of styrene and a polymerizable monomer selected from the group consisting of methacrylic acid, a methacrylate, acrylic acid, and an acrylate is preferable.

In order to adjust the molecular weight, a known polyfunctional polymerizable monomer and/or chain transfer agent may be added to these polymerizable monomers.

As for a method for manufacturing a polar resin preferably used for the present invention, the polymerization temperature in polymerization will be described. The polar resin used for the present invention is preferably manufactured by solution polymerization, and the polymerization temperature in that case is preferably set to 165° C. to 200° C. When the polymerization temperature is set in the above range, depolymerization of the polar resin in polymerization appropriately progresses, and the value A/B and the peak molecular weight Mp of the polar resin can be each set to an appropriate value. In addition, since gelation of the polar resin caused by an intramolecular reaction thereof, which is liable to occur when the polymerization temperature is set high, can be prevented beforehand, the image gloss of the toner can also be suppressed from being decreased.

The polymerization pressure in manufacturing of the polar resin of the present invention is preferably set to 0.075 to 0.500 MPa. When the polymerization pressure is set in the above range, an appropriate polymerization temperature for the present invention can be obtained. In addition, foaming in the polymerization can also be prevented, and adhesion of the polar resin to a reaction vessel can also be prevented. The above pressure is not an absolute pressure but indicates an applied pressure excluding the atmospheric pressure. In addition, as a solvent used for solution polymerization of the polar resin, a solvent having good solubility to the polar resin and a polymerizable monomer used therefor is preferable, and a solvent having a boiling point of 120° C. to 160° C. is preferable. When the boiling point of the solvent is set in the above range, even if polymerization is performed by applying a pressure, a good polymerization condition can be obtained. In particular, non-uniform polymerization caused by bumping during the polymerization can be prevented, and solvent removal can be easily performed after the polymerization is completed.

Hereinafter, measurement methods of physical properties of the polar resin of the present invention will be described below.

(1) The peak molecular weight Mp of the GPC chromatogram according to the present invention was measured as described below.

First, a measurement sample was formed as described below. The polar resin and THF were mixed together to have a concentration of 5 mg/ml, and the mixture was left to stand still for 24 hours at room temperature. Subsequently, the mixture was allowed to pass through a sample treatment filter (Maeshori Disc H-25-2, manufactured by Tosoh Corp., or Ekikurodisk 25CR, manufactured by Gelman Sciences Japan Ltd.), so that a sample for GPC was prepared.

Next, measurement was performed using a GPC measurement apparatus (HLC-8120 GPC, manufactured by Tosoh Corp.) in accordance with an operations manual thereof under the following measurement conditions.

### Measurement Conditions

Apparatus: High speed gel permeation chromatography “HLC-8120 GPC” (manufactured by Tosoh Corp.)

Column: combination of seven columns, Shodex KF-801, 802, 803, 804, 805, 806, and 807 (manufactured by Showa Denko K.K.)

Eluent: tetrahydrofuran (THF)

Flow rate: 1.0 ml/min

Oven temperature: 40.0° C.

Amount of injected sample: 0.10 ml

In addition, to calculate the molecular weight of the sample, a molecular weight calibration curve was used which was prepared using a standard polystyrene-based resin (the trade name “TSK Standard Polystyrene F-850, F-450, F-288, F-128, F-80, F-40, F-20, F-10, F-4, F-2, F-1, A-5000, A-2500, A-1000, and A-500, manufactured by Tosoh Corp.), and the peak molecular weight Mp was computed.

(2) The ratio S1 of the low molecular weight component of the polar resin and the ratio S2 of the high molecular weight component thereof were obtained in such a way that after the peak molecular weight Mp was obtained, a molecular weight portion lower than Mp and a molecular weight portion higher than Mp are separated from each other in a measurement chart of the GPC chromatogram, and the respective areas were computed.

(3) Preparative isolation of the low molecular weight component of the polar resin and the high molecular weight component thereof was carried out as follows.

### Preparative Isolation of Each Component

### Apparatus Configuration

LC-908 (manufactured by Japanese Analytical Industry Co., Ltd.)

JRS-86 (Repeat injector, manufactured by Japanese Analytical Industry Co., Ltd.)

JAR-2 (Auto-sampler, manufactured by Japanese Analytical Industry Co., Ltd.)

FC-201 (Fraction Collector, manufactured by GILSON Co.)

### Column Configuration

JAIGEL-1H to 5H (20 mm in diameter by 600 mm in length: preparative column)

### Measurement Conditions

Temperature: 40° C.

Solvent: THF

Flow rate: 5 ml/min.

Detector: RI

An elution time for the peak molecular weight Mp of the polar resin is measured beforehand, and a component eluted before the elution time for the peak molecular weight Mp and a component eluted after the elution time therefor are preparatively isolated as the high molecular weight component and the low molecular weight component, respectively. The solvent is removed from the sample thus isolated, so that the low molecular weight component L and the high molecular weight component H are obtained.

(4) The acid value of the polar resin, the acid value A of the low molecular weight component, and the acid value B of the high molecular weight component are measured by the following method.

The acid value is measured according to JIS K 0070-1966 and, in particular, is measured along the following procedure.

### (i) Preparation of Reagents

Phenolphthalein in an amount of 1.0 g is dissolved in 90 ml of ethyl alcohol (95 percent by volume), and ion exchange water is added to obtain 100 ml of a “phenolphthalein solution”.

Reagent grade potassium hydroxide in an amount of 7 g is dissolved in 5 ml of water, and ethyl alcohol (95 percent by volume) is added to obtain 1 liter of a solution. This solution received in an alkali-resistance container is left to stand still for 3 days so as not to be in contact with a carbon dioxide gas and the like and is then filtered, so that a “potassium hydroxide solution” is obtained. The potassium hydroxide solution thus obtained is stored in an alkali-resistance container. Standardization is performed according to JIS K 0070-1996.

### (ii) Operation

### (A) Main Test

After 2.0 g of the sample is measured in a 200-ml conical flask, 100 ml of a mixed solution of toluene/ethanol

(2:1) is added thereto, and the sample is dissolved over 5 hours. Subsequently, several drops of the phenolphthalein solution are added as an indicator, and titration is performed using the potassium hydroxide solution. In this case, the end point of the titration is determined when a light red color of the indicator is continuously shown for approximately 30 seconds.

### (B) Blank Test

Titration similar to that of the above operation is performed except that the sample is not used (that is, only the mixed solution of toluene/ethanol (2:1) is used). (iii) The acid value is computed by substituting the obtained result in the following formula.

A=[(B−C)×f×5.61]/S

In this formula, A represents the acid value (mgKOH/g), B represents the addition amount (ml) of the potassium hydroxide solution in the blank test, C represents the addition amount (ml) of the potassium hydroxide solution in the main test, f represents the factor of the potassium hydroxide solution, and S represents the mass (g) of the sample.

(5) The glass transition temperature Tg of the polar resin is obtained from the DSC curved in a first temperature rise step by operating the temperature as described below.

### Measurement Conditions

1) An equilibrium state is maintained at 20° C. for 5 minutes. 2) A modulation of 1.0° C./min is used so that the temperature is increased to 140° C. at a rate of 1° C./min. 3) An equilibrium state is maintained at 140° C. for 5 minutes. 4) The temperature is decreased to 20° C.

As a differential scanning calorimeter (DSC apparatus), for example, DSC-7 (manufactured by PerkinElmer Co., Ltd.) or DSC2920 (manufactured by TA Instrument Japan) is used, and the following measurement is performed in accordance with ASTM D3418-82. As the amount of a measurement sample, 2 to 5 mg and preferably 3 mg is precisely measured. After the sample is placed in an Al-made pan, and an empty Al-made pan is used as the reference, the measurement is performed in a measurement range of 20° C. to 140° C. under the above conditions. In this case, the glass transition temperature of the present invention is the value obtained by the midpoint method.

As a polymerizable monomer used when the toner of the present invention is manufactured by a suspension polymerization method, a vinyl polymerizable monomer which has high compatibility with the above polar resin and which can perform a radical polymerization is used. As the vinyl polymerizable monomer, a monofunctional polymerizable monomer or a polyfunctional polymerizable monomer may be used. As the monofunctional polymerizable monomer, for example, there may be mentioned styrene; styrene derivatives, such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers, such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxy ethyl acrylate; methacrylic polymerizable monomers, such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters, such as vinyl acetate, vinyl propionate, vinyl butyrate, vinyl benzoate, and vinyl formate; vinyl ethers, such as vinyl methyl ether, vinyl ethyl ether, and vinyl isobutyl ether; and vinyl ketones, such as vinyl methyl ketone, vinyl hexyl ketone, and vinyl isopropyl ketone.

As the polyfunctional polymerizable monomer, for example, there may be mentioned diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, trimethylolpropane trimethacrylate, tetramethylolmethane tetramethacrylate, divinylbenzene, divinylnaphthalene, and divinyl ether.

In the present invention, the monofunctional polymerizable monomers mentioned above may be used alone or in combination, or the monofunctional polymerizable monomers and the polyfunctional polymerizable monomers may be used in combination. The polyfunctional polymerizable monomers each may also be used as a cross-linking agent.

In addition, in the present invention, in order to control the degree of polymerization of the polymerizable monomer, for example, a known chain transfer agent, polymerization inhibitor, and the like may also be added.

In order to enable the toner of the present invention to have a desirable molecular weight distribution, a low molecular weight polymer may be contained in the polymerizable monomer composition. As the low molecular weight polymer, a polymer having a weight average molecular weight (Mw) of 2,000 to 5,000 measured by a gel permeation chromatography (GPC) and an Mw/Mn of less than 4.5 is preferably used. Mw/Mn is more preferably less than 3.0.

As the low molecular weight polymer, for example, a low molecular weight polystyrene, a low molecular weight styrene-acrylate copolymer, and a low molecular weight styrene-acrylic copolymer may be mentioned.

In addition, in the present invention, a wax may be contained in the toner particle. As the wax, for example, there may be mentioned a petroleum wax and its derivative, such as a paraffin wax, a microcrystalline wax, and a petrolatum wax; a montan wax and its derivative; a hydrocarbon wax by a Fischer Tropsch method and its derivative; a polyolefin wax and its derivative, such as a polyethylene wax and a polypropylene wax; and a natural wax and its derivative, such as a carnauba wax and a candelilla wax. As the derivatives, for example, an oxide, a block copolymer with a vinyl monomer, and a graft modified compound may also be mentioned. Furthermore, for example, there may also be mentioned a higher aliphatic alcohol; a fatty acid, such as stearic or and palmitic acid; an acid amide wax; an ester wax; a hydrogenated castor oil and its derivative; a vegetable wax; and an animal wax. Among those mentioned above, since having an excellent releasing property, in particular, an ester wax and a hydrocarbon wax are preferable. More preferably, a wax containing 50 to 95 percent by mass of compounds, the total numbers of carbon atoms of which are equal to each other, is more preferable in view of the development property, and the effect of the present invention can be easily obtained.

To 100.0 parts by mass of the binder resin, 1.0 to 40.0 parts by mass of the wax is preferably contained. The content is more preferably 3.0 to 25.0 parts by mass.

As a black colorant used for the present invention, carbon black, magnetic substances, and black colorants prepared using the following yellow/magenta/cyan colorants are used. In particular, since many types of dyes and carbon black contain a polymerization inhibition property, the use thereof must be sufficiently checked.

As a yellow colorant used for the present invention, for example, compounds represented by a condensed azo compound, an isoindolinone compound, an anthraquinone compound, an azo metal complex, a methine compound, and an allyl amide compound may be mentioned. In particular, for example, there may be mentioned C. I. Pigment Yellows 12, 13, 14, 15, 17, 62, 73, 74, 83, 93, 94, 95, 97, 109, 110, 111, 120, 128, 129, 138, 147, 150, 151, 154, 155, 168, 180, 185 and 214.

As a magenta colorant used for the present invention, a condensed azo compound, a diketo pyrrolo pyrrole compound, anthraquinone, a quinacridone compound, a base dye lake compound, a naphthol compound, a benzimidazolone compound, a thioindigo compound, and a perylene compound may be mentioned by way of example. In particular, for example, there may be mentioned C. I. Pigment Reds 2, 3, 5, 6, 7, 23, 48:2, 48:3, 48:4, 57:1, 81:1, 122, 146, 166, 169, 177, 184, 185, 202, 206, 220, 221, 238, 254, 269, and C.I. Pigment Violet 19.

As a cyan colorant used for the present invention, for example, a copper phthalocyanine compound and its derivative, an anthraquinone compound, and a base dye lake compound may be mentioned. In particular, for example, there may be mentioned C.I. Pigment Blues 1, 7, 15, 15:1, 15:2, 15:3, 15:4, 60, 62, and 66.

These colorants may be used alone or in combination and furthermore may also be used in a solid solution state. The colorant is selected in consideration of the hue angle, saturation, brightness, light resistance, OHP transparency, and dispersibility in the toner. To 100.0 parts by mass of the polymerizable monomer, 1.0 to 20.0 parts by mass of the colorant is preferably added.

Furthermore, the toner of the present invention may be formed as a magnetic toner using a magnetic substance as the colorant. In this case, the magnetic substance may also function as the colorant. As the magnetic substance, for example, there may be mentioned iron oxides, such as magnetite, hematite, and ferrite; metals, such as iron, cobalt, and nickel; and alloys or mixtures between the above metals and metals such as aluminum, cobalt, copper, lead, magnesium, tin, zinc, antimony, beryllium, bismuth, cadmium, calcium, manganese, selenium, titanium, tungsten, and vanadium.

As the magnetic substance, a substance processed by a hydrophobizing treatment using a surface treatment agent, such as a silane coupling agent or a titanium coupling agent, is preferably used.

These magnetic substances each preferably has a number average particle diameter of 2 μm or less and more preferably 0.1 to 0.5 μm. To 100.0 parts by mass of the polymerizable monomer, the amount of the magnetic substance contained in the toner particle is preferably 20.0 to 200.0 parts by mass and more preferably 40.0 to 150.0 parts by mass.

In addition, for the purpose of charge control and/or granulation stabilization in an aqueous medium, a polymer having a sulfonic acid function group (a sulfonic acid group, a sulfonic acid salt, or a sulfonic acid ester) is preferably contained in the monomer composition.

As a monomer having a sulfonic acid group for manufacturing the above polymer, for example, there may be mentioned styrene sulfonic acid, 2-acrylamido-2-methylpropane sulfonic acid, 2-methacrylamide-2-methylpropane sulfonic acid, vinyl sulfonic acid, and methacrylic sulfonic acid.

Although the polymer containing a sulfonic acid function group used for the present invention may be a homopolymer of the above monomer, a copolymer of the above monomer and another monomer may also be used. As a vinyl polymerizable monomer which forms a copolymer with the monomer, a monofunctional polymerizable monomer or a polyfunctional polymerizable monomer may be used. As the monomers described above, the polymerizable monomers mentioned above by way of example which can be used to obtain the binder resin may also be used.

To 100.0 parts by mass of the polymerizable monomer, 0.01 to 5.0 parts by mass of the polymer having a sulfonic acid function group is preferably contained. The content thereof is more preferably 0.1 to 3.0 parts by mass.

In order to stabilize the charging performance, besides the polymer having a sulfonic acid function group, a charge control agent may also be contained in the toner of the present invention. As the charge control agent, a known charge control agent may be used, and in particular, a charge control agent which has a rapid charging speed and which can stably maintain a predetermined charge amount is preferable. Furthermore, when the toner is manufactured by a direct polymerization method, in particular, a charge control agent which has a low polymerization inhibiting property and which contains substantially no substance soluble in an aqueous dispersion medium is preferable.

Among the above charge control agents, as a charge control agent which controls a toner to have a negative charge polarity, for example, an organometallic compound and a chelate compound may be mentioned. In particular, for example, a monoazo metal compound, an acetylacetone metal compound, and metal compounds of an aromatic oxycarboxylic acid, an aromatic dicarboxylic acid, an oxycarboxylic acid, and a dicarboxylic acid may be mentioned. Besides those mentioned above, aromatic oxycarboxylic acids, aromatic mono- and poly-carboxylic anhydrides, esters, and phenol derivatives, such as a bisphenol, may be mentioned by way of example. Furthermore, for example, a urea derivative, a metal-containing naphthoic acid compound, a boron compound, a quarternary ammonium salt, a calixarene, and a resin-based charge control agent may also be mentioned.

In addition, as a charge control agent which controls a toner to have a positive charge polarity, for example, there may be mentioned nigrosine and a nigrosine-modified product modified by a fatty metal salt; a guanidine compound; an imidazole compound; a quaternary ammonium salt such as tributylbenzylammonium-1-hydroxy-4-naphthosulfonic acid salt or tetrabutylammonium tetrafluoroborate; an onium salt, such as a phosphonium salt, which is an analog of the above quaternary ammonium salt, and a lake pigment thereof; a triphenylmethane dye or a lake pigment thereof (for example, a laking agent includes phosphorus tungstate, phosphorus molybdate, phosphorus tungstatemolybdate, tannin acid, lauric acid, gallic acid, a ferricyanide, and a ferrocyanide); a metal salt of a higher fatty acid; and a resin-based charge control agent.

Of those charge control agents, a metal-containing salicylic acid compound is preferable, and in particular, the metal is preferably aluminum or zirconium. The most preferable charge control agent is an aluminum compound of 3,5-di-tert-butylsalicylate.

To 100.0 parts by mass of the binder resin or the polymerizable monomer, the addition amount of the charge control agent is preferably 0.01 to 20.0 parts by mass and more preferably 0.5 to 10.0 parts by mass. However, for the toner of the present invention, the addition of the charge control agent is not essential, and by positively using frictional charging with a toner support and/or a toner-layer thickness regulating member, the charge control agent is not always necessarily contained in the toner.

To the toner of the present invention, an inorganic fine powder may be externally added in order to improve the fluidity and/or to uniform the frictional charging.

In addition, the inorganic fine powder to be externally added to toner particles preferably contains at least a silica fine powder. The number average particle diameter of primary particles of the silica fine powder is preferably 4 to 80 nm. In the present invention, when the number average particle diameter of the primary particles is in the above range, the fluidity of the toner is improved, and the storage stability thereof is also improved.

The number average particle diameter of the primary particles of the above inorganic fine powder is measured as described below.

The number average particle diameter of the primary particles is obtained in such a way that 100 diameters of the inorganic fine powder particles in one viewing field are observed and measured using a scanning electron microscope.

In addition, as the inorganic fine powder, titanium oxide, alumina, or a composite oxide fine powder thereof may be used together with a silica fine powder. As the inorganic fine powder to be used therewith, titanium oxide is preferable.

The above silica fine powder includes two types of fine powders, that is, so-called dry silica or fumed silica, which is produced by vapor phase oxidation of a silicon halide, and wet silica produced from water glass. As the silica described above, dry silica having a small number of silanol groups on the surface and inside of the silica and a small amount of manufacturing residues Na₂O and SO₃²⁻ is preferable. In addition, as the dry silica, a composite fine powder of silica and another metal oxide can also be obtained, for example, by using a silicon halide together with another metal halide, such as aluminum chloride or titanium chloride, in a manufacturing process. The silica also includes those mentioned above.

Since functions to adjust the frictional charge amount of the toner, improve the environmental stability, improve the performance under high humidity environment, and the like can be obtained when the inorganic fine powder is processed by a hydrophobizing treatment, an inorganic fine powder processed thereby is preferably used. When the inorganic fine powder externally added to the toner particles absorbs moisture, the frictional charge amount as the toner is decreased, and the development property and/or the transfer property is liable to be degraded.

As the agent used for a hydrophobizing treatment of the inorganic fine particles, for example, there may be mentioned unmodified silicone varnishes, various modified silicone varnishes, unmodified silicone oils, various modified silicone oils, silane compounds, silane coupling agents, other organic silicone compounds, and organic titanium compounds. Those treatment agents mentioned above may be used alone or in combination.

Among those mentioned above, an inorganic fine powder processed by a silicone oil is preferable. In addition, when an inorganic fine powder is treated with a silicone oil simultaneously with or after a hydrophobizing treatment using a coupling agent, it is more preferable since the frictional charge amount of toner particles can be maintained high even under a high humidity environment, and selective development can be suppressed.

Hereinafter, a method for manufacturing the toner particles will be described using a suspension polymerization method by way of example which is preferable to obtain toner particles used for the present invention. For production of toner particles, a polymerizable monomer used for manufacturing the binder resin, a colorant, a polar resin, and, if needed, other additives are uniformly dissolved or dispersed using a dispersion machine, such as a homogenizer, a ball mill, a colloid mill, or an ultrasonic dispersion machine. A polymerization initiator is dissolved in the above mixture, so that a polymerizable monomer composition is prepared. Next, toner particles are manufactured by suspending and polymerizing the polymerizable monomer composition in an aqueous medium containing a dispersant. The above polymerization initiator may be added to the polymerizable monomer at the same time when the other additives are added thereto or are mixed with the polymerizable monomer immediately before the polymerizable monomer composition is suspended in the aqueous medium. In addition, immediately after the granulation and before the start of a polymerization reaction, the polymerization initiator dissolved in the polymerizable monomer or a solvent may also be added.

As the dispersant, known inorganic and organic dispersants may be used. In particular, as the inorganic dispersant, for example, there may be mentioned tricalcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina. On the other hand, as the organic dispersant, for example, there may be mentioned a poly(vinyl alcohol), gelatin, methylcellulose, methylhydroxypropylcellulose, ethylcellulose, a sodium salt of carboxymethylcellulose, and starch.

In addition, as the dispersant, commercially available nonion, anion, and cation type surfactants may also be used. As such a surfactant, for example, there may be mentioned sodium dodecyl sulfate, sodium tetradecyl sulfate, sodium pentadecyl sulfate, sodium octyl sulfate, sodium oleate, sodium laurate, potassium stearate, and calcium oleate.

As the dispersant, an inorganic dispersant having poor water solubility is preferable, and furthermore, an inorganic dispersant which has poor water solubility and which is soluble in an acid is more preferable.

In addition, in the present invention, when an inorganic dispersant having poor water solubility is used to prepare an aqueous dispersion medium, the amount of the dispersant with respect to 100 parts by mass of the polymerizable monomer is preferably 0.2 to 2.0 parts by mass. In addition, in the present invention, with respect to 100 parts by mass of the polymerizable monomer composition, 300 to 3,000 parts by mass of water is preferably used to prepare an aqueous dispersion medium.

As the polymerization initiator, an oil-soluble initiator and/or a water-soluble initiator may be used. An initiator having a half life of 0.5 to 30 hours at a polymerization temperature of the polymerization reaction is preferable. In addition, when 0.5 to 20 parts by mass of the initiator is used to 100 parts by mass of the polymerizable monomer for the polymerization reaction, in general, a polymer having the maximum between a molecular weight of 10,000 and that of 100,000 is obtained, and a toner which has appropriate strength and melt properties can be obtained.

As a polymerization initiator necessary to polymerize the polymerizable monomer, for example, there may be mentioned azo or diazo polymerization initiators, such as 2,2′-azobis(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators, such as benzoyl peroxide, t-butyl peroxy-2-ethylhexanoate, t-butyl peroxy pivalate, t-butyl peroxy isobutyrate, t-butyl peroxy neodecanoate, methyl ethyl ketone peroxide, diisopropyl peroxy carbonate, cumene hydroperoxide, 2,4-dichlorobenzoyl peroxide, and lauroyl peroxide.

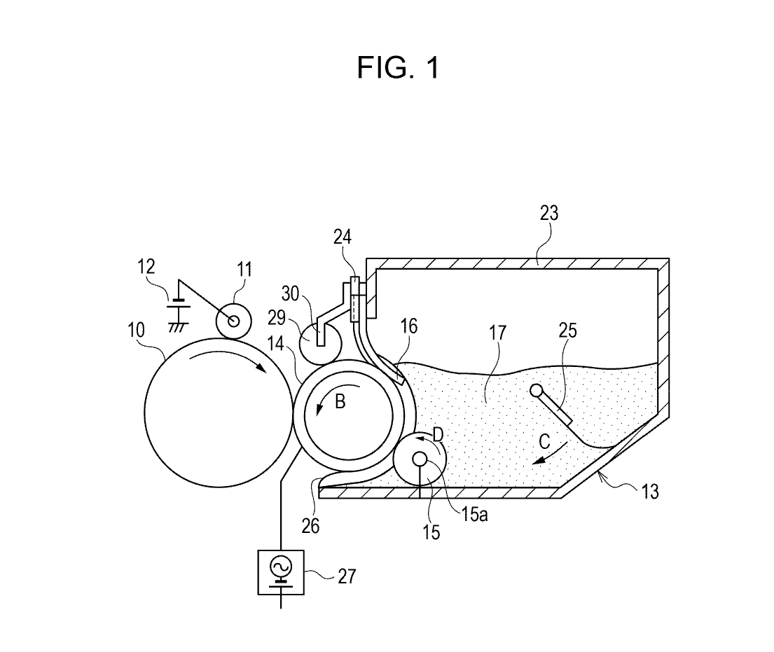

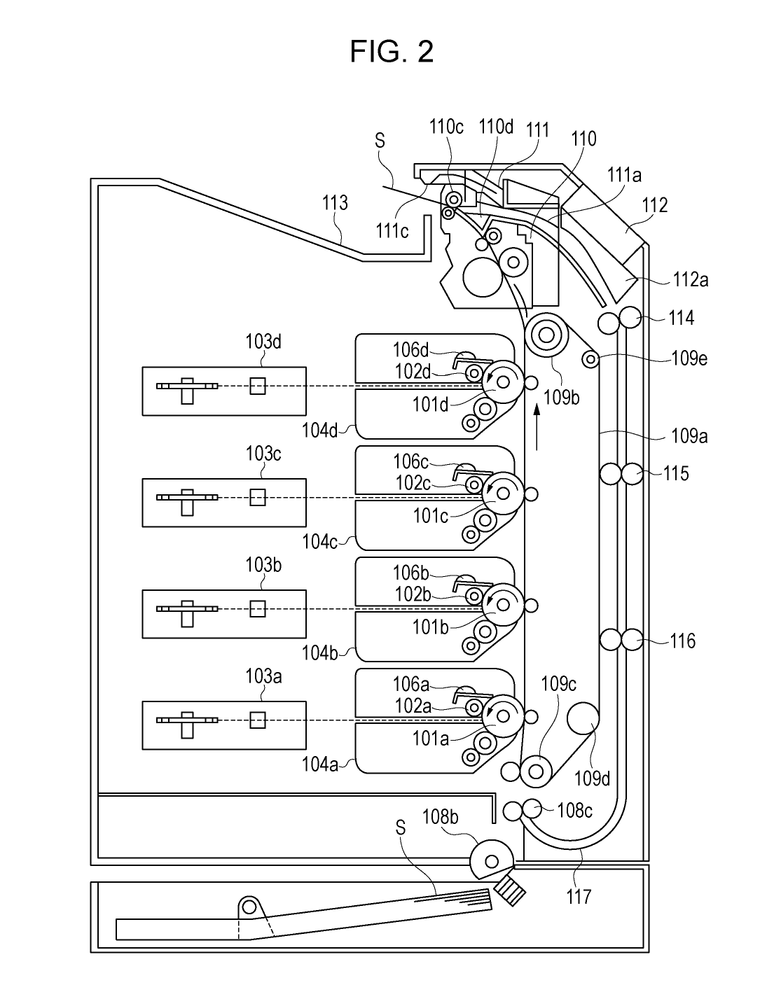

Next, an image formation method which can use the toner of the present invention will be described with reference to FIGS. 1 and 2.

An image formation apparatus shown in FIG. 2 is a tandem type laser beam printer using an electrophotographic process.

In FIG. 2, reference numeral 101 (101a to 101d) indicates a drum-type electrophotographic photo conductor (hereinafter referred to as “photoconductor drum”) functioning as a latent image support which rotates at a predetermined process speed in an arrow direction shown in the figure (counterclockwise direction). The photoconductor drums 101a, 101b, 101c, and 101d are responsible for a yellow (Y) component, a magenta (M) component, a cyan (C) component, and a black (Bk) component, respectively, of a color image in this order.

Hereinafter, the image formation apparatuses of Y, M, C and Bk are called a unit a, a unit b, a unit c, and a unit d, respectively. Although rotated by a drum motor (direct-current servo motor) not shown in the figure, these photoconductor drums 101a to 101d may be each provided with an independent drive source. The rotation drive of the drum motor is controlled by a digital signal processor (DSP) not shown in the figure, and the other control is performed by a CPU not shown in the figure.

In addition, an electrostatic adsorption conveyor belt 109a is fitted around a drive roller 109b, a fixed rollers 109c and 109e, and a tension roller 109d and is rotated in an arrow direction shown in the figure by the drive roller 109b to convey a recording medium S by adsorption.

Hereinafter, among the four colors, the unit a (yellow) will be described as an example.

A primary charging treatment is performed uniformly on the photoconductor drum 101a by a primary charging device 102a in a rotation process to have predetermined polarity and electric potential. In addition, light image exposure is performed by a laser beam exposure device (hereinafter referred to as a “scanner”) 103a to the photoconductor drum 101a, so that an electrostatic latent image is formed thereon.

Next, a toner image is formed on the photoconductor drum 101a by a developing section 104a, so that the electrostatic latent image is visualized. A process similar to that described above is carried out for each of the other three colors (magenta (B), cyan (C), and black (Bk)).

Subsequently, the toner images of the four colors are synchronized by a resist roller 108c which stops and again conveys the recording medium S conveyed by a sheet feed roller 108b at a predetermined timing and are sequentially transferred on the recording medium S at respective nip portions between the photoconductor drums 101a to 101d and the electrostatic adsorption conveyor belt 109a. In addition, at the same time, adherent residues, such as toners left after the transfer, on the photoconductor drums 101a to 101d after the toner image transfer to the recording medium S are removed by cleaning devices 106a to 106d, so that image formation is repeatedly performed.

The recording medium S on which the toner images are transferred from the four photoconductor drums 101a to 101d is separated from the surface of the electrostatic adsorption conveyor belt 109a at the drive roller 109b, is then fed to a fixing device 110 so that the toner images are fixed therein, and is finally discharged to a discharge tray 113 by a discharge roller 110c.

In addition, reference numerals 102b to 102d each indicate a primary charging device, reference numerals 103b to 103d each indicate a scanner, reference numerals 104b to 104d each indicate a developing section, reference numeral 110d indicates a two-side print mode sheet guide, reference numeral 111 indicates an air duct, reference numeral 111a indicates a guide rib, reference numeral 112 indicates a control panel, reference numeral 112a indicates a guide rib, reference numerals 114 to 116 each indicate a pair of two-sided print mode rollers, and reference numeral 117 indicates a U-turn guide.

Next, with reference to an enlarged view (FIG. 1) of the developing section, a particular example of an image formation method by a non-magnetic one-component contact development system will be described. As shown in FIG. 1, a development unit 13 includes a developer container 23 containing a non-magnetic toner 17 as a one-component developer and a toner support 14 located at an opening portion of the developer container 23 extending in a longitudinal direction thereof to face a latent image support (photoconductive drum) 10 and is configured to visualize an electrostatic latent image on the latent image support 10 by development. A latent image support contact charging member 11 is in contact with the latent image support 10. A bias of the latent image support contact charging member 11 is applied by a power supply 12.

An approximately one half of the circumferential surface of the toner support 14 at the right side shown in the figure protrudes in the developer container 23 through the opening portion, and an approximately one half of the circumferential surface of the toner support 14 at the left side is exposed outside of the developer container 23. The surface exposed outside of this developer container 23 is in contact with the latent image support 10 located at the left side of the development unit 13 as shown in FIG. 1.

The toner support 14 is rotary driven in an arrow B direction, the circumferential speed of the latent image support 10 is 50 to 170 mm/s, and the toner support 14 is rotated at a circumferential speed of one to two times that of the latent image support 10.

At an upper portion of the toner support 14, a regulating member 16 is supported by a regulating member support plate 24, a part the regulating member 16 in the vicinity of a front end at a free end side thereof is provided so as to be in contact with the circumference of the toner support 14 by a surface contact, and the contact direction thereof is a so-called counter direction in which the front end side is located at an upstream side of the rotation direction of the toner support 14 with respect to the contact portion. The regulating member 16 includes, for example, a metal plate, such as stainless steel plate, a rubber material, such as an urethane or a silicone rubber, or a metal thin plate, such as a phosphor bronze or a stainless steel thin plate, having an elastic modulus as a base material, and a rubber material, such as an urethane rubber, adhered to a contact surface side thereof to the toner support 14. A contact pressure (linear pressure) of the regulating member 16 to the toner support 14 is preferably 20 to 300 N/m. In addition, measurement of the contact pressure is performed in such a way that three metal thin plates each have a known friction coefficient are inserted in the contact portion, and the contact pressure is converted from a value obtained by pulling out the central metal thin plate by a spring balance. As the regulating member 16, a rubber material or the like is adhered to the contact surface side is preferable since melting and fixing of the toner to the regulating member can be suppressed for a long-term use. In addition, the front end of the regulating member 16 may also be in an edge contact with the toner support 14. When the edge contact is performed, if the contact angle of the regulating member to the tangent line of the toner support at a point of the contact therewith is set to 40° or less, it is more preferable in view of layer regulation of the toner.

A toner supply roller 15 is in contact with the toner support 14 at an upper stream side in a rotation direction with respect to the contact portion of the regulating member 16 to the surface of the toner support 14 and is rotatably supported. As a contact width of this toner supply roller 15 to the toner support 14, 1 to 8 mm is effective, and in addition, the toner supply roller 15 is preferably configured to have a relative speed at the contact portion with respect to the toner support 14.

Although not indispensable to the image formation method of the present invention, a charging roller 29 is more preferably provided. The charging roller 29 is an elastic body, such as an NBR or a silicone rubber, and is fitted to a suppression member 30. A contact load of the charging roller 29 to the toner support 14 by this suppression member 30 is set to 0.49 to 4.9 N. A toner layer on the toner support 14 is closely packed and uniformly coated by the contact of the charging roller 29. As for the longitudinal positional relationship of the regulating member 16 and the charging roller 29, the charging roller 29 is preferably arranged so as to reliably cover the whole contact area of the regulating member 16 on the toner support 14.

In addition, the charging roller 29 must be driven at the same circumferential speed as that of the toner support 14 or must be driven thereby, and when the difference in circumferential speed is generated between the charging roller 29 and the toner support 14, it is not preferable since a toner coating is not uniformly performed, and unevenness is generated on the image.

A bias of the charging roller 29 is applied by a direct current between the toner support 14 and the latent image support 10 by a power supply 27 (shown in FIG. 1), and the non-magnetic toner 17 on the toner support 14 receives a charge by discharge from the charging roller 29.

The bias of the charging roller 29 is a bias of the same polarity as the non-magnetic toner and not less than a discharge starting voltage and is set to generate a potential difference of 1,000 to 2,000 V to the toner support 14.

After receiving a charge by the charging roller 29, a thin toner layer formed on the toner support 14 is uniformly conveyed to a developing section facing the latent image support 10.

In this developing section, the thin toner layer formed on the toner support 14 is developed as a toner image in accordance with an electrostatic latent image on the latent image support 10 by a direct current bias applied between the toner support 14 and the latent image support 10 by the power supply 27 shown in FIG. 1. In addition, reference numeral 15a indicates a mandrel, reference numeral 25 indicates a toner stirring member, and reference numeral 26 indicates a toner leakage preventing member.

### EXAMPLES

The present invention will be particularly described with reference to the following examples. Hereinafter, methods for manufacturing a polar resin and a toner will be described. The “part(s)” and “%” in Examples and Comparative Examples are all on the mass basis unless otherwise particularly noted.

### Manufacturing Example 1 of Polar Resin

After 300 parts by mass of xylene (boiling point: 144° C.) was charged in a pressurizable and pressure-reducible flask, and the atmosphere inside the flask was sufficiently replaced with nitrogen while stirring was performed, the temperature was increased, and reflux was performed.

Under this reflux condition, the following mixture was added, and polymerization was then performed at a polymerization temperature of 175° C. and a reaction pressure of 0.100 MPa for 5 hours. Then, after a solvent removal step was performed at a reduced pressure for 3 hours to remove xylene, grinding was performed, so that a polar resin A was obtained.

| | |
|---|---|
| Styrene | 95.85 parts by mass |
| Methyl methacrylate | 2.50 parts by mass |
| Methacrylic acid | 1.65 parts by mass |
| Di-tert-butyl peroxide | 2.00 parts by mass |

### Manufacturing Example 2 of Polar Resin

Except that the addition amount of di-tert-butyl peroxide was changed to 5 parts by mass, a polar resin B was obtained in a manner similar to that in Manufacturing Example 1.

### Manufacturing Example 3 of Polar Resin

Except that the addition amount of di-tert-butyl peroxide was changed to 0.1 parts by mass, a polar resin C was obtained in a manner similar to that in Manufacturing Example 1.

### Manufacturing Example 4 of Polar Resin

Except that the polymerization temperature was changed to 168° C., a polar resin D was obtained in a manner similar to that in Manufacturing Example 1.

### Manufacturing Example 5 of Polar Resin

Except that the polymerization temperature was changed to 195° C., and the reaction pressure was changed to 0.240 Mpa, a polar resin E was obtained in a manner similar to that in Manufacturing Example 1.

### Manufacturing Example 6 of Polar Resin

Except that the formulation was changed as shown below, a polar resin F was obtained in a manner similar to that in Manufacturing Example 1.

| | |
|---|---|
| Styrene | 96.50 parts by mass |
| Methyl methacrylate | 2.50 parts by mass |
| Methacrylic acid | 1.00 parts by mass |
| Di-tert-butyl peroxide | 2.00 parts by mass |

### Manufacturing Example 7 of Polar Resin

Except that the formulation was changed as shown below, a polar resin G was obtained in a manner similar to that in Manufacturing Example 1.

| | |
|---|---|
| Styrene | 91.16 parts by mass |
| Methyl methacrylate | 2.50 parts by mass |
| Methacrylic acid | 6.34 parts by mass |
| Di-tert-butyl peroxide | 2.00 parts by mass |

### Manufacturing Example 8 of Polar Resin

Except that the formulation was changed as shown below, a polar resin H was obtained in a manner similar to that in Manufacturing Example 1.

| | |
|---|---|
| Styrene | 83.85 parts by mass |
| Methyl methacrylate | 2.50 parts by mass |
| Methacrylic acid | 1.65 parts by mass |
| n-Butyl acrylate | 12.00 parts by mass |
| Di-tert-butyl peroxide | 2.00 parts by mass |

### Manufacturing Example 9 of Polar Resin

Except that the formulation was changed as shown below, a polar resin I was obtained in a manner similar to that in Manufacturing Example 1.

| | |
|---|---|
| Styrene | 65.85 parts by mass |
| Methyl methacrylate | 2.50 parts by mass |
| Methacrylic acid | 1.65 parts by mass |
| Acryloyl morpholine | 30.00 parts by mass |
| Di-tert-butyl peroxide | 2.00 parts by mass |

### Manufacturing Example 10 of Polar Resin

Except that the formulation was changed as shown below, a polar resin J was obtained in a manner similar to that in Manufacturing Example 1.

| | |
|---|---|
| Styrene | 95.55 parts by mass |
| Methyl methacrylate | 2.50 parts by mass |
| Methacrylic acid | 1.65 parts by mass |
| Divinylbenzene | 0.30 parts by mass |
| Di-tert-butyl peroxide | 2.00 parts by mass |

### Manufacturing Example 11 of Polar Resin

Except that the formulation was changed as shown below, a polar resin K was obtained in a manner similar to that in Manufacturing Example 1.

| | |
|---|---|
| Styrene | 95.55 parts by mass |
| Methyl methacrylate | 2.50 parts by mass |
| Methacrylic acid | 1.65 parts by mass |
| Trimethylolethane thioglycolate | 0.50 parts by mass |
| (chain transfer agent) | |
| di-tert-butyl peroxide | 2.00 parts by mass |

### Manufacturing Example 12 of Polar Resin

Except that the formulation was changed as shown below, a polar resin L was obtained in a manner similar to that in Manufacturing Example 1.

| | |
|---|---|
| Styrene | 94.66 parts by mass |
| Methyl methacrylate | 2.50 parts by mass |
| 4-vinylbenzoic acid | 2.84 parts by mass |
| Di-tert-butyl peroxide | 2.00 parts by mass |

### Manufacturing Example 13 of Polar Resin

Except that the polymerization temperature was changed to 165° C., and the polymerization pressure was changed to 0.073 MPa, a polar resin M was obtained in a manner similar to that in Manufacturing Example 1.

### Manufacturing Example 14 of Polar Resin

Except that the polymerization pressure was changed to 0.520 MPa, a polar resin N was obtained in a manner similar to that in Manufacturing Example 1.

### Manufacturing Example 15 of Polar Resin

Except that the solvent was changed from xylene to toluene (boiling point: 111° C.), the polymerization temperature was changed to 170° C., and the polymerization pressure was changed to 0.330 MPa, a polar resin O was obtained in a manner similar to that in Manufacturing Example 1.

### Manufacturing Example 16 of Polar Resin

Except that the solvent was changed from xylene to m-dichlorobenzene (boiling point: 173° C.), a polar resin P was obtained in a manner similar to that in Manufacturing Example 1.

### Manufacturing Example 17 of Polar Resin

Except that the polymerization temperature was changed to 160° C., a polar resin Q was obtained in a manner similar to that in Manufacturing Example 1.

### Manufacturing Example 18 of Polar Resin

Except that the polymerization temperature was changed to 210° C., and the polymerization pressure was changed to 0.330 MPa, a polar resin R was obtained in a manner similar to that in Manufacturing Example 1.

### Manufacturing Example 19 of Polar Resin

Except that the polymerization temperature was changed to 140° C., a polar resin a was obtained in a manner similar to that in Manufacturing Example 1.

### Manufacturing Example 20 of Polar Resin

Except that the polymerization temperature was changed to 220° C., and the polymerization pressure was changed to 0.440 MPa, a polar resin b was obtained in a manner similar to that in Manufacturing Example 1.

### Manufacturing Example 21 of Polar Resin

Except that the formulation was changed as shown below, a polar resin c was obtained in a manner similar to that in Manufacturing Example 1.

| | |
|---|---|
| Styrene | 90.65 parts by mass |
| Methyl methacrylate | 2.50 parts by mass |
| Methacrylic acid | 6.85 parts by mass |
| Di-tert-butyl peroxide | 2.00 parts by mass |

### Manufacturing Example 22 of Polar Resin

Except that the formulation was changed as shown below, a polar resin d was obtained in a manner similar to that in Manufacturing Example 1.

| | |
|---|---|
| Styrene | 96.74 parts by mass |
| Methyl methacrylate | 2.50 parts by mass |
| Methacrylic acid | 0.76 parts by mass |
| Di-tert-butyl peroxide | 2.00 parts by mass |

### Manufacturing Example 23 of Polar Resin

Except that the addition amount of di-tert-butyl peroxide was changed to 8.00 parts by mass, a polar resin e was obtained in a manner similar to that in Manufacturing Example 1.

### Manufacturing Example 24 of Polar Resin

Except that the addition amount of di-tert-butyl peroxide was changed to 0.05 parts by mass, a polar resin f was obtained in a manner similar to that in Manufacturing Example 1.

### Manufacturing Example 25 of Polar Resin

### i) Manufacturing of Aromatic Carboxylic Acid Titanium Compound

In a four-port glass flask, placed in a mantle heater, having a volume of 4 liters and equipped with a thermometer, a stirring bar, a condenser, and a nitrogen introduction tube, 65.3 parts by mass of isophthalic acid and 18 parts by mass of ethylene glycol were mixed together and dissolved at a temperature of 100° C., and subsequently, dehydration was performed under a reduced pressure condition. Next, after cooling was performed to 50° C., 18.9 parts by mass of titanium tetramethoxide was added in a nitrogen atmosphere. Then, methanol, which was a reaction product, was distilled off by reducing the pressure inside the flask, so that an aromatic carboxylic acid titanium compound was obtained.

### ii) Manufacturing of Polar Resin

First, 3.65 mol of polyoxypropylene(2.2)-2,2-bis(4-hydroxyphenyl)propane, 6.21 mol of isophthalic acid, and 0.14 mol of trimellitic anhydride were weighed. Next, after 100 parts of the mixture of the above acids and alcohol and 0.3 parts of the aromatic carboxylic acid titanium compound were charged in a four-port glass flask having a volume of 4 liters, the flask was equipped with a thermometer, a stirring bar, a condenser, and a nitrogen introducing tube and was then placed in a mantle heater. In a nitrogen atmosphere, a reaction was performed at 230° C., so that a polar resin g was obtained.

The physical properties of the polar resins A to R and a to g are shown in Table 1.

TABLE 1

| | | RATIO OF UNIT | | | WHOLE | | | |
|---|---|---|---|---|---|---|---|---|
| | | DERIVED | MAIN PEAK | | ACID | | | |
| | | FROM STYRENE | MOLECULAR | | VALUE | | | |
| | | (PERCENT | WEIGHT | | (mgKOH/ | S1/ | Tg | |
| No. | COMPOSITION | BY MASS) | Mp | A/B | g) | S2 | (° C.) | REMARK |
| POLAR RESIN A | St-MMA-MAA | 95.82 | 14500 | 0.98 | 10.9 | 1.3 | 90.0 | — |
| POLAR RESIN B | St-MMA-MAA | 95.81 | 7800 | 1.00 | 10.8 | 1.4 | 74.1 | — |
| POLAR RESIN C | St-MMA-MAA | 95.82 | 96000 | 1.05 | 10.8 | 1.3 | 98.8 | — |
| POLAR RESIN D | St-MMA-MAA | 95.83 | 14500 | 0.83 | 10.7 | 1.3 | 89.7 | — |
| POLAR RESIN E | St-MMA-MAA | 95.80 | 14500 | 1.16 | 10.5 | 1.4 | 90.1 | — |
| POLAR RESIN F | St-MMA-MAA | 96.42 | 14500 | 0.98 | 6.1 | 1.4 | 90.1 | — |
| POLAR RESIN G | St-MMA-MAA | 91.10 | 15200 | 0.98 | 38.4 | 1.3 | 90.8 | — |
| POLAR RESIN H | St-MMA-MAA-BA | 83.82 | 15500 | 0.98 | 10.5 | 1.3 | 68.7 | — |
| POLAR RESIN I | St-MMA-MAA-ACMO | 65.81 | 14800 | 0.99 | 10.8 | 1.7 | 112.0 | — |
| POLAR RESIN J | St-MMA-MAA-DVB | 95.49 | 16800 | 0.98 | 11.1 | 0.9 | 91.1 | — |
| POLAR RESIN K | St-MMA-MAA | 95.50 | 12500 | 0.98 | 10.2 | 2.0 | 87.6 | — |
| POLAR RESIN L | St-MMA-4VBA | 94.65 | 16500 | 1.11 | 12.5 | 1.4 | 87.3 | — |
| POLAR RESIN M | St-MMA-MAA | 95.80 | 13400 | 0.89 | 9.9 | 1.3 | 89.9 | — |
| POLAR RESIN N | St-MMA-MAA | 95.81 | 14700 | 1.19 | 10.6 | 1.3 | 90.0 | FOAMING WAS VIGOROUS |
| | | | | | | | | IN POLYMERIZATION |
| POLAR RESIN O | St-MMA-MAA | 95.79 | 15200 | 0.81 | 11.2 | 1.2 | 90.0 | VIGOROUS BUMPING |
| | | | | | | | | OCCURRED |
| POLAR RESIN P | St-MMA-MAA | 95.80 | 14900 | 0.82 | 10.3 | 1.3 | 91.0 | 12 HOURS WAS REQUIRED |
| | | | | | | | | FOR SOLVENT REMOVAL |
| | | | | | | | | STEP |
| POLAR RESIN Q | St-MMA-MAA | 95.81 | 13200 | 0.80 | 9.9 | 1.3 | 90.3 | — |
| POLAR RESIN R | St-MMA-MAA | 95.81 | 5800 | 1.11 | 10.1 | 1.3 | 88.9 | — |
| POLAR RESIN a | St-MMA-MAA | 95.83 | 17600 | 0.78 | 10.4 | 1.2 | 93.2 | — |
| POLAR RESIN b | St-MMA-MAA | 95.79 | 18200 | 1.26 | 10.5 | 1.3 | 87.6 | — |
| POLAR RESIN c | St-MMA-MAA | 90.61 | 15500 | 1.01 | 41.2 | 1.6 | 85.2 | — |
| POLAR RESIN d | St-MMA-MAA | 96.70 | 18200 | 0.91 | 4.8 | 1.3 | 91.2 | — |
| POLAR RESIN e | St-MMA-MAA | 95.80 | 4800 | 0.99 | 10.5 | 1.6 | 72.1 | — |
| POLAR RESIN f | St-MMA-MAA | 95.83 | 114000 | 1.02 | 10.3 | 1.2 | 105.1 | — |
| POLAR RESIN g | PEs | — | 8700 | 1.18 | 8.0 | 1.8 | 73.4 | — |

St: STYRENE
MMA: METHYL METHACRYLATE
MAA: METHACRYLIC ACID
BA: BUTYL ACRYLATE
ACMO: ACRYLOYL MORPHOLINE
4VBA: 4-VINYLBENZOIC ACID
DVB: DIVINYLBENZENE
PEs: POLYESTER

### Example 1

A toner (A) was manufactured by the following procedure. To 1,300 parts by mass of ion exchange water warmed at a temperature of 60° C., 9 parts by mass of tricalcium phosphate and 11 parts by mass of 10% hydrochloric acid were added, and the mixture thus prepared was stirred at 10,000 r/min using a TK type homomixer (manufactured by Special Machinery Chemical Industries Co., Ltd.) to prepare an aqueous medium.

In addition, the following materials were dissolved by a propeller type stirring machine at 100 r/min to prepare a solution.

| | |
|---|---|
| Styrene | 69.0 parts by mass |
| n-Butyl acrylate | 31.0 parts by mass |
| Sulfonic acid group-containing resin | 2.0 parts by mass |
| (acrylic base FCA-1001-NS, manufactured by | |
| FUJIKURA KASEI Co., Ltd.) | |
| Polar resin A | 20.0 parts by mass |

Next, the following materials were added to the solution.

| | |
|---|---|
| C.I. Pigment Blue 15:3 | 7.0 parts by mass |
| Negative charge control agent (BONTRON E-88, | 0.7 parts by mass |
| manufactured by Orient Chemical Industry Co., | |
| Ltd.) | |
| Hydrocarbon wax (endothermic peak | 8.0 parts by mass |
| temperature: 77° C.) (HNP-51, manufactured by | |
| NIPPON SEIRO K.K.) | |

Subsequently, the mixed liquid thus prepared was heated to a temperature of 60° C. and was then stirred at 9,000 r/min by a TK type homomixer (manufactured by Special Machinery Chemical Industries Co., Ltd) for dissolution and dispersion.

In this mixture thus processed, 8.0 parts by mass of a polymerization initiator 2,2′-azobis(2,4-dimethylvaleronitrile) was dissolved, so that a polymerizable monomer composition was prepared. The polymerizable monomer composition was charged in the above aqueous medium, and stirring was performed at a temperature of 60° C. using a TK type homomixer for 10 minutes at 15,000 r/min, so that granulation was performed.

Subsequently, after the granulated product was transferred to a propeller type stirring machine and was allowed to react at a temperature of 70° C. for 5 hours while stirring was performed at 100 r/min, the temperature was increased to 80° C., and a reaction was further performed for 5 hours, so that toner particles were manufactured. After the polymerization reaction was completed, a slurry containing the above particles was cooled and was then washed using water in an amount 10 times that of the slurry, and after filtration and drying were performed, the toner particles were obtained by adjusting the size distribution by classification.

As a fluidity improver, 2.0 parts by mass of a hydrophobic silica fine powder (number average particle diameter of primary particles: 10 nm, BET specific surface area: 170 m²/g, the powder was processed by 20 percent by mass of a dimethyl silicone oil with respect to a silica base material and was frictionally charged to the same polarity as that of the toner particles) was mixed with 100 parts by mass of the above toner particles by a Henschel mixer (manufactured by Mitsui Miike Machinery Co., Ltd.) for 15 minutes at 3,000 r/min, so that the toner (A) was obtained. In addition, the following evaluations were performed on the toner (A) thus obtained. The evaluation results are shown in Tables 3 and 4.

### Examples 2 to 23 and Comparative Examples 1 to 7

Except that the type of polar resin and the addition amount thereof were changed as shown in Table 2, toners (B) to (W) and toners (a) to (g) were obtained in a manner similar to that of Example 1.

In addition, for the toner (W) of Example 23, two types of polar resins were added together for use. The following evaluations were performed on the toners thus obtained in a manner similar to that in Example 1. The evaluation results are shown in Tables 3 and 4.

TABLE 2

| | | POLAR RESIN | |
|---|---|---|---|
| | | | ADDITION |
| | | | AMOUNT |
| | | | (PARTS BY |
| | | TYPE | MASS) |
| EXAMPLE 1 | TONER (A) | POLAR RESIN A | 20.0 |
| EXAMPLE 2 | TONER (B) | POLAR RESIN B | 20.0 |
| EXAMPLE 3 | TONER (C) | POLAR RESIN C | 20.0 |
| EXAMPLE 4 | TONER (D) | POLAR RESIN D | 20.0 |
| EXAMPLE 5 | TONER (E) | POLAR RESIN E | 20.0 |
| EXAMPLE 6 | TONER (F) | POLAR RESIN F | 20.0 |
| EXAMPLE 7 | TONER (G) | POLAR RESIN G | 20.0 |
| EXAMPLE 8 | TONER (H) | POLAR RESIN A | 9.0 |
| EXAMPLE 9 | TONER (I) | POLAR RESIN A | 28.0 |
| EXAMPLE 10 | TONER (J) | POLAR RESIN H | 20.0 |
| EXAMPLE 11 | TONER (K) | POLAR RESIN I | 20.0 |
| EXAMPLE 12 | TONER (L) | POLAR RESIN J | 20.0 |
| EXAMPLE 13 | TONER (M) | POLAR RESIN K | 20.0 |
| EXAMPLE 14 | TONER (N) | POLAR RESIN A | 7.0 |
| EXAMPLE 15 | TONER (O) | POLAR RESIN A | 32.0 |
| EXAMPLE 16 | TONER (P) | POLAR RESIN L | 20.0 |
| EXAMPLE 17 | TONER (Q) | POLAR RESIN M | 20.0 |
| EXAMPLE 18 | TONER (R) | POLAR RESIN N | 20.0 |
| EXAMPLE 19 | TONER (S) | POLAR RESIN O | 20.0 |
| EXAMPLE 20 | TONER (T) | POLAR RESIN P | 20.0 |
| EXAMPLE 21 | TONER (U) | POLAR RESIN Q | 20.0 |
| EXAMPLE 22 | TONER (V) | POLAR RESIN R | 20.0 |
| EXAMPLE 23 | TONER (W) | POLAR RESIN A | 15.0 |
| | | POLAR RESIN g | 4.0 |
| COMPARATIVE | TONER (a) | POLAR RESIN a | 20.0 |
| EXAMPLE 1 | | | |
| COMPARATIVE | TONER (b) | POLAR RESIN b | 20.0 |
| EXAMPLE 2 | | | |
| COMPARATIVE | TONER (c) | POLAR RESIN c | 20.0 |
| EXAMPLE 3 | | | |
| COMPARATIVE | TONER (d) | POLAR RESIN d | 20.0 |
| EXAMPLE 4 | | | |
| COMPARATIVE | TONER (e) | POLAR RESIN e | 20.0 |
| EXAMPLE 5 | | | |
| COMPARATIVE | TONER (f) | POLAR RESIN f | 20.0 |
| EXAMPLE 6 | | | |
| COMPARATIVE | TONER (g) | POLAR RESIN g | 20.0 |
| EXAMPLE 7 | | | |

The evaluation method and the evaluation criteria in this example will be described below.

### Evaluation on Fixability

The developer container of the developing device of the one-component contact development system shown in FIG. 1 was filled with 85 g of a toner for evaluation and was left to stand still for 24 hours under ordinary temperature/ordinary humidity conditions (temperature: 23.5° C., and relative humidity: 60%). In this case, the transfer sheets were also left to stand still in a manner to that described above. Subsequently, under the ordinary temperature/ordinary humidity conditions (temperature: 23.5° C., and relative humidity: 60%), the developing device shown in FIG. 1 was fitted to the unit c section of FIG. 2, and an unfixed image was output in a cyan monochrome mode at a process speed of 250 mm/s.

### Low Temperature Fixability

An unfixed solid image having a toner amount of 0.7 mg/cm² was obtained by using plain paper (64 g/m² paper) for a copying machine as a transfer material. The image was fixed by a fixing device IRC3200 (manufactured by CANON KABUSHIKI KAISHA) at a process speed of 250 mm/s. The fixing temperature was decreased from 200° C. to 130° C. at 5° C. intervals. The image was reciprocated five times with lens-cleaning paper to which a load of 4.9 kPa was applied, and a temperature at which a density decrease rate of 20% or more was obtained was evaluated as a lower limit fixing temperature.

A: The lower limit fixing temperature is less than 145° C.
B: The lower limit fixing temperature is 145° C. to less than 155° C.
C: The lower limit fixing temperature is 155° C. to less than 165° C.
D: The lower limit fixing temperature is 165° C. or more.

### High-Temperature Offset Resistance

An unfixed image was obtained by using a Xerox 4200 (manufactured by Xerox Corporation) (75 g/m² paper) as a transfer material. In the unfixed image, the toner amount of a solid image portion was 0.45 mg/cm², the entire region from the tip to a portion at a distance of 5 cm therefrom when an A4-size was horizontally placed was a solid image portion, and the other region was solid white. This image was fixed by a fixing device IRC3200 at a fixing temperature from 170° C. to 200° C. set at 5° C. intervals. The image was fixed at a process speed of 40 mm/s. The level of offset shown in the white portion was visually inspected. The following levels A, B, and C cause no problems in use.

A: No offset occurs.
B: At a fixing temperature of 200° C., slight offset occurs at an end of the white portion.
C: At a fixing temperature of 200° C., offset occurs over the transfer material.
D: At a fixing temperature of 190° C., offset occurs over the transfer material.

### Image Glossiness

An unfixed solid image having a toner amount of 0.5 mg/cm² was obtained by using a Xerox 4200 (75 g/m² paper). The solid image was fixed by a fixing device IRC3200 at a process speed of 150 mm/s and at a fixing temperature of 180° C. An image glossiness at a measurement optical portion angle of 75° was measured by using a “PG-3D” (manufactured by NIPPON DENSHOKU INDUSTRIES Co., LTD.).

A: The image glossiness is 25 or more.
B: The image glossiness is 20 to less than 25.
C: The image glossiness is 18 to less than 20.
D: The image glossiness is less than 18.

### Fixing Roller Winding Resistance

As the transfer material, plain paper for a copying machine (64 g/m² paper) was used for the evaluation. An unfixed solid image having a toner amount of 1.1 mg/cm² was formed on the transfer paper from 1 mm apart from the tip thereof. This image was fixed using a fixing device IRC3200 at a process speed of 250 mm/s by decreasing the fixing temperature from 175° C. at 5° C. intervals. The evaluation was performed on the temperature at which the transfer paper started to wind around a fixing roller.

A: The temperature is 155° C. or less.
B: The temperature is more than 155° C. to 160° C.
C: The temperature is more than 160° C. to 165° C.
D: The temperature is more than 165° C.

### Blister Test

An unfixed solid image having a toner amount of 0.7 mg/cm² was obtained by using plain paper for a copying machine (105 g/m² paper) as a transfer material. The image was fixed by a fixing device IRC3200 (manufactured by CANON KABUSHIKI KAISHA) at a process speed of 250 mm/s and a fixing temperature of 190° C. Blister is a phenomenon in which an image is partially peeled off by a fixing roller in a fixing step since a sufficient amount of heat is not applied to toner particles. The level of the blister was visually evaluated.

A: No blister is generated.
B: The blister is slightly generated.
C: The blister is generated.
D: The blister is remarkably generated.

### Bending Test

An unfixed solid image having a toner amount of 0.7 mg/cm² was obtained by using plain paper for a copying machine (64 g/m² paper) as a transfer material. This image was fixed by a fixing device IRC3200 (manufactured by CANON KABUSHIKI KAISHA) at a process speed of 250 mm/s and a fixing temperature of 190° C. Subsequently, the image portion was bent. As bending conditions, a flat weight was reciprocally moved five times along the bent portion while a load of 4.9 kPa was applied thereto. Next, the bent image portion was reciprocally rubbed five times with lens-cleaning paper to which a load of 4.9 kPa was applied, and the density decrease rate before and after the rubbing was measured.

A: The density decrease rate is less than 5%.
B: The density decrease rate is 5% to less than 10%.
C: The density decrease rate is 10% to less than 15%.
D: The density decrease rate is 15% or more.

### Evaluation on Storage Stability

### Blocking Test

A toner in an amount of 10 g was placed in a 50-ml polycup. After the toner was left to stand still in a temperature control bath at 55° C. for 72 hours, the condition of the toner was visually inspected as follows.

A: No blocking occurs, and the condition is substantially identical to the initial condition.
B: Slight agglomeration tends to occur but is likely to be collapsed by rotation of the polycup.
C: Agglomeration tends to occur but is likely to be collapsed and loosened with hands.
D: Agglomeration remarkably occurs (solidification).

### Evaluation on Development Property

The developer container of the developing device of the one-component contact development system shown in FIG. 1 was filled with 70 g of the toner of each of Examples and Comparative Examples and was left to stand still for 24 hours under ordinary temperature/ordinary humidity conditions (temperature: 23.5° C., and relative humidity: 60%). In this case, the transfer sheets were also left to stand still in a manner similar to that described above. In addition, a Xerox 4200 (manufactured by Xerox Corporation) (75 g/m² paper) was used as the transfer paper for the evaluation on the development property. Subsequently, under the ordinary temperature/ordinary humidity conditions (temperature: 23.5° C., and relative humidity: 60%), the developing device shown in FIG. 1 was fitted to the unit c section of FIG. 2. Continuous output was performed using a chart having a print rate of 2% in a cyan monochromatic mode at a process speed of 250 mm/s. Evaluation of the development property was performed at the first stage (first sheet)/5,000-th sheet/10,000-th sheet, and the image density and the fogging were inspected by the following methods.

### Image Density

A relative density for an image having a white portion with an original density of 0.00 was measured as the image density by using a “Macbeth reflection densitometer RD918” (manufactured by Macbeth Co.).

A: The image density is 1.40 or more.
B: The image density is 1.30 to less than 1.40.
C: The image density is 1.20 to less than 1.30.
D: The image density is 1.10 to less than 1.20.

### Fogging

In a fogging evaluation method, after an image having a white portion was output, a fogging density (%) (=Dr(%)−Ds(%)) was calculated from the difference between the degree of whiteness of the white portion of the printed-out image (reflectance Ds(%)) and the degree of whiteness of the transfer paper (average reflectance Dr (%)) measured by using a “REFLECTMETER MODEL TC-6DS” (manufactured by Tokyo Denshoku Co., Ltd.), and image fogging was evaluated when an endurance test was completed. An amberlite filter was used as a filter.

A: The fogging density is less than 0.5%.
B: The fogging density is 0.5% to less than 1.0%.
C: The fogging density is 1.0% to less than 1.5%.
D: The fogging density is 1.5% or more.

### Evaluation on Transfer Property

As in the case of the evaluation on the development property, the developer container of the developing device of the one-component contact development system shown in FIG. 1 was filled with 70 g of the toner of each of Examples and Comparative Examples and was left to stand still for 24 hours under high temperature/high humidity conditions (temperature: 30° C., and relative humidity: 85%). In this case, the transfer sheets were also left to stand still in a manner similar to that described above. Subsequently, the developing device shown in FIG. 1 was fitted to the unit c section of FIG. 2. Continuous output was performed using a chart having a print rate of 2% in a cyan monochromatic mode at a process speed of 250 mm/s under high temperature/high humidity conditions (temperature: 30° C., and relative humidity: 85%). Evaluation of the transfer efficiency/the transfer uniformity was performed at the first stage (first sheet)/5,000-th sheet/10,000-th sheet.

### Transfer Efficiency

A Xerox 4200 (75 g/m² paper) was used as the transfer paper. A power source of a main body was forcedly turned off while a whole solid image (having a toner amount of 0.6 mg/cm²) was output on one sheet (in a transfer step). The mass of the toner on a photosensitive drum per unit area before the transfer and the mass of the toner transferred on the transfer material per unit area were measured, and the transfer efficiency was measured by the following equation.

Transfer efficiency=100×(toner transferred on transfer material/toner on photosensitive drum before transfer)

A: The transfer efficiency is 90% or more.
B: The transfer efficiency is 82% to less than 90%.
C: The transfer efficiency is 75% to less than 82%.
D: The transfer efficiency is less than 75%.

### Transfer Uniformity

A Fox River Bond (manufactured by Fox River Paper) (90 g/m² paper) was used as transfer paper. The transfer uniformity was visually evaluated using a whole halftone image having a toner amount of 0.20 mg/cm².

A: All images are excellent in transfer uniformity.
B: Some images are slightly inferior in transfer uniformity.
C: Some images are inferior in transfer uniformity.
D: Images are seriously inferior in transfer uniformity.

TABLE 3

| | | EVALUATION ON FIXABILITY | | | | | |
|---|---|---|---|---|---|---|---|
| | | LOW TEMPERATURE | | | WINDING | | |
| | | FIXABILITY | | | RESISTANCE | | |
| | | ( ) INDICATES | | | ( ) INDICATES | | BENDING TEST |
| | | LOWER LIMIT | HIGH- | IMAGE GLOSS | LOWER | | ( ) INDICATES |
| | | FIXING | TEMPERATURE | ( ) INDICATES | LIMIT WINDING | | DENSITY |
| | | TEMPERATURE | OFFSET | IMAGE | TEMPERATURE | BLISTER | DECREASE |
| | | (° C.) | RESISTANCE | GLOSSINESS | (° C.) | TEST | RATE (%) |
| EXAMPLE 1 | TONER (A) | A(135) | A | A(31) | A(140) | A | A(0) |
| EXAMPLE 2 | TONER (B) | A(140) | A | A(28) | A(140) | A | A(2) |
| EXAMPLE 3 | TONER (C) | B(145) | A | B(24) | B(160) | B | A(2) |
| EXAMPLE 4 | TONER (D) | B(145) | A | B(23) | B(160) | B | A(3) |
| EXAMPLE 5 | TONER (E) | A(140) | B | A(30) | A(145) | A | A(2) |
| EXAMPLE 6 | TONER (F) | A(140) | B | A(29) | A(145) | A | A(3) |
| EXAMPLE 7 | TONER (G) | B(150) | A | B(23) | B(160) | B | A(3) |
| EXAMPLE 8 | TONER (H) | A(140) | A | A(27) | A(145) | A | A(4) |
| EXAMPLE 9 | TONER (I) | B(150) | A | B(24) | B(160) | B | B(7) |
| EXAMPLE 10 | TONER (J) | A(140) | B | A(26) | A(145) | A | A(3) |
| EXAMPLE 11 | TONER (K) | B(150) | A | B(24) | B(160) | B | C(13) |
| EXAMPLE 12 | TONER (L) | C(160) | B | B(22) | B(160) | B | B(7) |
| EXAMPLE 13 | TONER (M) | A(140) | A | A(26) | A(145) | B | A(2) |
| EXAMPLE 14 | TONER (N) | A(140) | B | A(26) | A(145) | A | A(3) |
| EXAMPLE 15 | TONER (O) | B(150) | A | C(19) | B(160) | B | B(8) |
| EXAMPLE 16 | TONER (P) | B(150) | A | B(21) | B(160) | A | A(4) |
| EXAMPLE 17 | TONER (Q) | B(150) | A | B(22) | B(160) | B | A(3) |
| EXAMPLE 18 | TONER (R) | A(140) | C | A(26) | A(145) | A | A(3) |
| EXAMPLE 19 | TONER (S) | B(145) | A | C(19) | C(165) | B | C(12) |
| EXAMPLE 20 | TONER (T) | C(160) | A | A(27) | B(160) | A | A(4) |
| EXAMPLE 21 | TONER (U) | C(160) | A | C(19) | C(165) | B | C(14) |
| EXAMPLE 22 | TONER (V) | A(140) | B | C(19) | A(145) | A | A(2) |
| EXAMPLE 23 | TONER (W) | B(145) | B | A(27) | B(160) | B | A(3) |
| COMPARATIVE | TONER (a) | B(150) | A | C(18) | C(165) | D | A(2) |
| EXAMPLE 1 | | | | | | | |
| COMPARATIVE | TONER (b) | A(140) | D | A(30) | B(160) | A | A(3) |
| EXAMPLE 2 | | | | | | | |
| COMPARATIVE | TONER (c) | C(165) | A | C(18) | C(165) | D | C(13) |
| EXAMPLE 3 | | | | | | | |
| COMPARATIVE | TONER (d) | A(140) | C | A(30) | A(145) | A | A(2) |
| EXAMPLE 4 | | | | | | | |
| COMPARATIVE | TONER (e) | A(140) | D | A(29) | A(145) | A | A(3) |
| EXAMPLE 5 | | | | | | | |
| COMPARATIVE | TONER (f) | D(170) | B | D(16) | D(170) | C | D(17) |
| EXAMPLE 6 | | | | | | | |
| COMPARATIVE | TONER (g) | B(150) | B | A(27) | B(160) | B | B(9) |
| EXAMPLE 7 | | | | | | | |

TABLE 4

| | | EVALUATION | EVALUATION ON | | EVALUATION ON | |
|---|---|---|---|---|---|---|
| | | ON STORAGE | DEVELOPMENT PROPERTY | | TRANSFER PROPERTY | |
| | | STABILITY | IMAGE DENSITY | FOGGING | TRANSFER EFFICIENCY | |
| | | BLOCKING | ( ) INDICATES IMAGE | ( ) INDICATES | ( ) INDICATES TRANSFER | TRANSFER |
| | | RESISTANCE | DENSITY VALUE | FOGGING VALUE | EFFICIENCY VALUE | UNIFORMITY |
| EXAMPLE 1 | TONER (A) | A | A(1.45)/A(1.44)/A(1.43) | A(0.1)/A(0.1)/A(0.2) | A(98)/A(96)/A(94) | A/A/A |
| EXAMPLE 2 | TONER (B) | B | A(1.45)/A(1.43)/B(1.39) | A(0.3)/B(0.6)/B(0.7) | A(97)/A(97)/A(93) | A/A/B |
| EXAMPLE 3 | TONER (C) | A | A(1.45)/A(1.44)/A(1.44) | A(0.2)/A(0.4)/A(0.4) | A(94)/A(94)/A(93) | A/A/A |
| EXAMPLE 4 | TONER (D) | A | A(1.44)/A(1.44)/A(1.42) | A(0.2)/A(0.4)/A(0.4) | A(95)/A(94)/A(93) | A/A/A |
| EXAMPLE 5 | TONER (E) | B | A(1.42)/B(1.38)/B(1.35) | A(0.3)/B(0.6)/B(0.8) | A(96)/A(93)/B(89) | A/A/B |
| EXAMPLE 6 | TONER (F) | B | A(1.42)/B(1.39)/B(1.31) | A(0.4)/B(0.7)/B(0.9) | A(96)/A(95)/B(88) | A/A/B |
| EXAMPLE 7 | TONER (G) | A | A(1.42)/A(1.42)/B(1.39) | A(0.2)/A(0.4)/B(0.8) | A(95)/A(92)/B(87) | A/A/B |
| EXAMPLE 8 | TONER (H) | B | A(1.43)/B(1.36)/B(1.32) | B(0.6)/B(0.7)/B(0.9) | A(96)/B(89)/B(86) | A/B/B |
| EXAMPLE 9 | TONER (I) | A | A(1.43)/A(1.41)/B(1.38) | A(0.2)/A(0.3)/A(0.4) | A(97)/A(94)/A(92) | A/A/A |
| EXAMPLE 10 | TONER (J) | B | A(1.41)/B(1.36)/B(1.34) | A(0.3)/A(0.4)/B(0.7) | A(92)/B(88)/B(87) | A/B/B |
| EXAMPLE 11 | TONER (K) | A | A(1.43)/A(1.41)/B(1.38) | A(0.2)/A(0.3)/A(0.4) | A(96)/A(95)/A(93) | A/A/A |
| EXAMPLE 12 | TONER (L) | B | A(1.42)/A(1.41)/A(1.40) | A(0.2)/A(0.3)/B(0.8) | A(94)/A(92)/A(91) | A/A/B |
| EXAMPLE 13 | TONER (M) | A | A(1.43)/B(1.36)/B(1.32) | A(0.3)/A(0.4)/B(0.7) | A(94)/B(89)/B(85) | B/B/B |
| EXAMPLE 14 | TONER (N) | C | A(1.42)/B(1.37)/B(1.35) | B(0.7)/B(0.8)/C(1.2) | A(91)/B(86)/B(85) | A/B/B |
| EXAMPLE 15 | TONER (O) | A | A(1.43)/B(1.36)/C(1.28) | A(0.2)/A(0.3)/A(0.4) | A(98)/A(96)/A(94) | A/A/A |
| EXAMPLE 16 | TONER (P) | B | A(1.42)/B(1.36)/C(1.27) | A(0.3)/B(0.6)/C(1.1) | A(96)/B(89)/B(84) | A/B/B |
| EXAMPLE 17 | TONER (Q) | A | A(1.43)/A(1.42)/A(1.41) | A(0.2)/A(0.2)/A(0.4) | A(97)/A(95)/A(92) | A/A/A |
| EXAMPLE 18 | TONER (R) | C | A(1.42)/B(1.33)/C(1.24) | A(0.3)/B(0.7)/C(1.3) | A(92)/B(86)/C(81) | A/B/B |
| EXAMPLE 19 | TONER (S) | A | A(1.41)/A(1.40)/B(1.36) | A(0.3)/A(0.4)/B(0.6) | A(96)/A(95)/B(88) | A/A/A |
| EXAMPLE 20 | TONER (T) | A | A(1.42)/A(1.42)/A(1.41) | A(0.2)/A(0.3)/A(0.4) | A(98)/A(97)/A(93) | A/A/A |
| EXAMPLE 21 | TONER (U) | A | A(1.41)/A(1.40)/B(1.35) | A(0.2)/A(0.4)/B(0.8) | A(97)/A(92)/B(89) | A/A/A |
| EXAMPLE 22 | TONER (V) | C | A(1.40)/C(1.26)/C(1.23) | A(0.3)/C(1.2)/C(1.4) | B(89)/B(86)/C(80) | B/C/C |
| EXAMPLE 23 | TONER (W) | B | A(1.42)/A(1.41)/B(1.37) | A(0.3)/B(0.7)/B(0.8) | A(98)/A(96)/A(92) | A/A/A |
| COMPARATIVE | TONER (a) | A | A(1.43)/A(1.41)/A(1.40) | A(0.2)/A(0.3)/A(0.4) | A(97)/A(96)/A(93) | A/A/A |
| EXAMPLE 1 | | | | | | |
| COMPARATIVE | TONER (b) | C | A(1.41)/C(1.26)/D(1.16) | A(0.2)/B(0.8)/C(1.4) | A(92)/C(81)/C(78) | A/C/D |
| EXAMPLE 2 | | | | | | |
| COMPARATIVE | TONER (c) | A | A(1.42)/B(1.38)/C(1.22) | B(0.6)/B(0.7)/C(1.4) | B(89)/B(86)/C(80) | B/B/B |
| EXAMPLE 3 | | | | | | |
| COMPARATIVE | TONER (d) | C | B(1.36)/C(1.26)/D(1.15) | B(0.7)/B(0.8)/C(1.3) | A(93)/B(88)/D(72) | A/B/C |
| EXAMPLE 4 | | | | | | |
| COMPARATIVE | TONER (e) | C | C(1.24)/C(1.22)/D(1.11) | C(1.1)/D(1.6)/D(1.8) | B(88)/C(78)/D(71) | C/C/D |
| EXAMPLE 5 | | | | | | |
| COMPARATIVE | TONER (f) | A | A(1.42)/A(1.42)/A(1.41) | A(0.3)/A(0.4)/A(0.4) | A(96)/A(95)/A(93) | A/A/A |
| EXAMPLE 6 | | | | | | |
| COMPARATIVE | TONER (g) | B | A(1.40)/C(1.22)/D(1.10) | B(0.8)/C(1.4)/D(1.8) | B(89)/D(74)/D(73) | C/D/D |
| EXAMPLE 7 | | | | | | |

In the table, as the development property and the transfer property, the evaluation results obtained from the first stage/5,000-th paper/10,000-th paper are shown.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-153629, filed Jul. 12, 2011, which is hereby incorporated by reference herein in its entirety.

1. A toner comprising toner particles
wherein:
the toner particles produced by a process including the steps of
adding a polymerizable monomer composition containing a polymerizable monomer, a polar resin, and a colorant to an aqueous medium;
granulating the polymerizable monomer composition in the aqueous medium; and
polymerizing the polymerizable monomer contained in the polymerizable monomer composition,
wherein:
i) the polar resin is a styrene-based polymer,
ii) a main peak molecular weight Mp in a GPC chromatogram of the polar resin is 5,000 to 100,000,
iii) the acid value of the polar resin is 5.0 to 40.0 mgKOH/g, and
iv) the polar resin satisfies the following relationship:
0.80≦A(mgKOH/g)/B(mgKOH/g)≦1.20
where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.

2. The toner according to claim 1, wherein the content of the polar resin is 8.0 to 30.0 parts by mass to the 100.0 parts by mass of the polymerizable monomer.

3. The toner according to claim 1, wherein the polar resin satisfies the following relationship:
1.0≦S1/S2≦1.8
where,
S1 represents a area rate of a lower-molecular weight component in a chart obtained by the GPC chromatogram and S2 represents a area rate of a higher-molecular weight component in a chart obtained by the GPC chromatogram when the chart is divided into two areas at the peak molecular weight Mp of the polar resin.

4. The toner according to claim 1, wherein the polar resin has a glass transition temperature Tg of 70° C. to 110° C.

5. The toner according to claim 1, wherein the polar resin is a resin manufactured by solution polymerization, and a polymerization temperature thereof is 165° C. to 200° C.

6. The toner according to claim 5, wherein the solution polymerization uses a solvent having a boiling point of 120° C. to 160° C.

7. The toner according to claim 5, wherein the polar resin is manufactured by polymerization at a pressure of 0.075 to 0.500 MPa.

8. The toner according to claim 1, wherein the polar resin is a polymer polymerized using styrene and at least one type of polymerizable monomer selected from the group consisting of methacrylic acid, a methacrylic acid ester, acrylic acid, and an acrylic ester.

9. A method for manufacturing a toner comprising the steps of:
(I) adding a polymerizable monomer composition containing a polymerizable monomer, a polar resin, and a colorant to an aqueous medium;
(II) granulating the polymerizable monomer composition in the aqueous medium; and
(III) polymerizing the polymerizable monomer contained in the polymerizable monomer composition to form toner particles,
wherein:
i) the polar resin is a styrene-based polymer,
ii) a main peak molecular weight Mp in a GPC chromatogram of the polar resin is 5,000 to 100,000,
iii) the acid value of the polar resin is 5.0 to 40.0 mgKOH/g, and
iv) said polar resin satisfies the following relationship:
0.80≦A(mgKOH/g)/B(mgKOH/g)≦1.20
where,
“A” and “B” represent acid values of a component L and a component H of the polar resin, the components L and H are respectively a lower-molecular weight polymer component and a higher-molecular weight polymer component when the polar resin is divided into two components at the peak molecular weight Mp of the polar resin, and wherein the component L contains a polymer whose molecular weight is less than the peak molecular weight Mp, and the component H contains a polymer whose molecular weight is not less than the peak molecular weight Mp.
